(19) United States
(12) Patent Application Publication
(10) Pub. No.: US 2011/0234160 A1
(43) Pub. Date: Sep. 29, 2011

(54) BATTERY CHARGER FOR CHARGING BATTERIES OF DIFFERENT SIZES

(76) Inventor: Stephen J. Smith, Shortsville, NY (US)

(21) Appl. No.: 12/748,855

(22) Filed: Mar. 29, 2010

(51) Int. Cl. H02J 7/00

(52) U.S. Cl. 320/110

(57) ABSTRACT

Battery charger for charging batteries of different sizes in which the batteries have first and second terminals on one side of the battery, the battery charger includes a charging platform for receiving a battery; first and second closed ends disposed on opposite ends of the charging platform; wherein one of the closed ends is movable in first and second directions that span across at least a portion of the platform for respecting increasing and decreasing an area of the platform in which the battery rests for receiving batteries of different sizes; a matrix of pogo pins disposed on one of the closed ends of the platform, wherein the pogo pins are configured to electrically contact the battery in a plurality of positions within a predetermined range; and one or more electronic components for detecting polarity of the battery; wherein charging of the battery is performed according to the detected polarity.

### FIELD OF THE INVENTION

The present invention generally relates to battery chargers and more particularly to battery chargers having a single, adjustable docketing station for accommodating batteries of different sizes and a detection mechanism for detecting the polarity of the battery and then charging accordingly.

### BACKGROUND OF THE INVENTION

Current electronic testing devices include pogo pins that contact terminals of the device being tested. For example, PCT Application WO 2007/013341 A1 includes a base having multiple pogo pins that “prevent damage to the electrode pads of the electronic component device and the first contacts when they are brought into contact with each other.” (See page 11) The PCT Application also discloses that, if different sized electronic components are tested, then another set of pogo pins are required. This limits this disclosure to having a set of pogo pins for each anticipated battery size. If the beforehand determination of the number of pogo pin sets is later concluded to be too small, a new or significantly modified apparatus would have to be constructed. (See page 14) Although satisfactory for the scope of testing envisioned by this application, it lacks flexibility to accommodate different sized electronic components within a single compact docking mechanism.

U.S. Pat. No. 4,816,735 discloses a battery charger having a plurality of separate supports—one for each size battery. A lock out feature is provided for preventing charging if the terminal size is not according to specification. Timing of the charge is regulated by the size of the battery and a sensing feature detects the size of the battery. Although satisfactory for the scope of testing envisioned, the separate supports enlarge the size of the charger and consequently its cost. Still further, the lock out feature is inflexible in its ability to charge batteries if the proper battery is not installed in the correct support, which makes the user have to obtain and retain its operation characteristics in order to efficiently operate. This is obviously not particular user friendly.

U.S. Pat. No. 5,686,808 discloses a battery charger having sensing features that detect voltage, temperature and the charging timing period for determining if these measurements are within a predetermined range. (See column 10, lines 46-54 and column 11, lines 9-11) These parameters are detected so that charging can proceed in the manner anticipated by this disclosure. A plurality of individual docking trays is used to accommodate batteries of different sizes so that a different tray accommodates each particular battery size. (See column 7, lines 12-30) Likewise, this disclosure is satisfactory for the anticipated scope of charging, but is obviously limited to its envisioned testing parameters such as unique docking trays and limited detection.

U.S. Pat. No. 7,449,875 B2 discloses a feature for detecting battery polarity. Like the previously cited prior art, if a different size battery is tested, a second detector terminal D is needed. (See column 2, lines 26-34) This imposes additional cost and greatly increases its size.

One reference then addressed the size drawbacks. In this regard, US Publication 2008/0143294 discloses a pocket having a floor in which retractable and extendable walls protrude through the floor for accommodating batteries of different sizes. Although satisfactory for its envisioned scope, the retractable walls include mechanical devices beneath the floor that are costly and also create mechanical reliability issues due to its complexity.

The present invention addresses each of these limited scopes of battery charging by including, in one aspect of the present invention, flexibility to charge different sized batteries on a single, adjustable platform that is cost efficient and operationally reliable. It further includes a polarity detection feature in combination with the single, adjustable platform.

### SUMMARY OF THE INVENTION

The present invention is directed to overcoming one or more of the problems set forth above. Briefly summarized, according to one aspect of the invention, the invention resides in a battery charger for charging batteries of different sizes in which the batteries have a first and second terminal on one side of the battery, the battery charger comprising (a) a charging platform for receiving a battery; (b) first and second closed ends disposed on opposite ends of the charging platform; wherein one of the closed ends is movable in first and second directions that span across at least a portion of the platform for respecting increasing and decreasing an area of the platform in which the battery rests for receiving batteries of different sizes; (b) a matrix of pogo pins disposed on one of the closed ends of the platform, wherein the pogo pins are configured to electrically contact the battery in a plurality of positions within a predetermined range; and (c) one or more electronic components for detecting polarity of the battery; wherein charging of the battery is performed according to the detected polarity.

These and other objects, features, and advantages of the present invention will become apparent to those skilled in the art upon a reading of the following detailed description when taken in conjunction with the drawings wherein there is shown and described an illustrative embodiment of the invention.

### ADVANTAGEOUS EFFECT OF THE INVENTION

The present invention has the advantage of including, in one aspect of the present invention, flexibility to charge different sized batteries on a single, adjustable platform.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

While the specification concludes with claims particularly pointing out and distinctly claiming the subject matter of the present invention, it is believed that the invention will be better understood from the following description when taken in conjunction with the accompanying drawings, wherein:

FIG. 1 is a perspective view of a battery charger of the present invention; and

FIG. 2 is also a perspective view of the battery charger of the present invention with a portion of the housing cut-away so that internal components of the battery charger can be better illustrated.

### DETAILED DESCRIPTION OF THE INVENTION

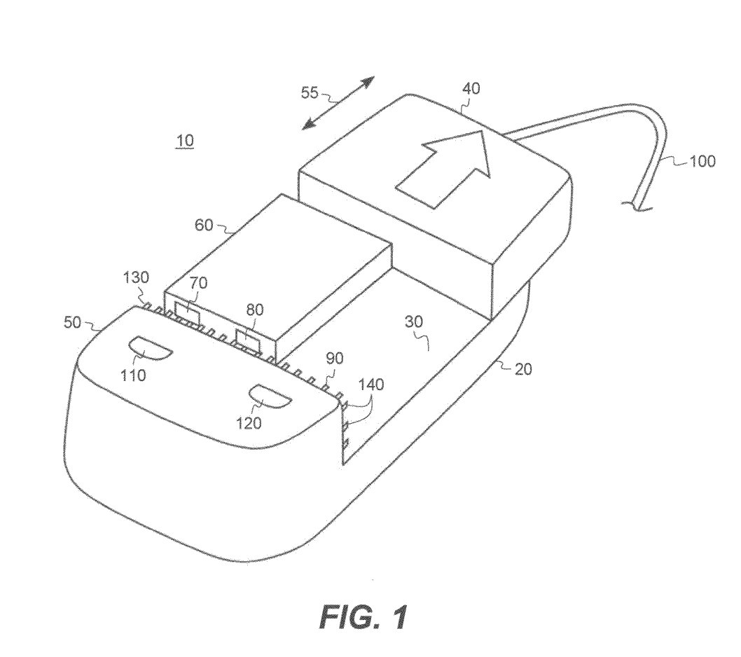

Turning now to FIG. 1, there is shown a perspective view of a battery charger 10 of the present invention. The battery charger 10 includes a housing 20 having a charging platform 30 (a single, undivided unit) with two closed ends 40 and 50 respectively on each end of the platform 30. A battery 60, when being charged, rests on the platform between the two closed ends 40 and 50. It is noted that the battery 60 includes two terminals 70 and 80 on a side of the battery, as is typical, that are used for charging the battery 60. One end 50 includes a matrix of pogo pins 90 in which the pins 90 move toward the closed end 50 when force is applied and returns to it normal position (as shown) when there is an absence of force.

The other end 40 (i.e., a movable, self-adjusting end) is adjustable inwardly toward the pogo pin end 50 and outwardly away from the pogo pin end 50 (as indicated by the arrows 55) for adjusting to the size of the particular battery being charged. The adjustable end 40 moves 40 in a sliding, bi-directional motion across the platform 30 so that the area of the platform 30 is decreased when the end 40 moves toward the other end 50, which decreases the length of the platform 30. The end 40 moves away from the other end 50 so that the area of the platform 30 is increased, which increases the length of the platform 30. The end 40 slides on one or more rails or grooves (not shown) and has a return spring for permitting the movement of the end 40. It is noted that the end 40 moves spanning across at least a portion of the platform 30 which, from a cost design and reliability standpoint, is more efficient in terms of cost and more reliable than retractable walls that extend and retract from a floor as in US Publication 2008/0143294. For clarity of distinction, it is reiterated that the present invention spans across the platform 30.

A power cord 100 is disposed on one end 40 for supplying power to the battery charger 10 for permitting battery charging. A charging display 110 and a ready display 120 are disposed on one of the ends 50 both of which light up to respectively indicate charging and to indicate charging is complete. More specifically, the battery charger 10 displays an indicator light via the charging display 110 for indicating initiation of successful charging of the battery. The battery charger 10 of the present invention is not limited to the display features shown but may also include other consumer-oriented features for creating a user-friendly battery charger. It is noted that the present invention eliminates the need for an indication light representing improper orientation since the present invention can accept any orientation as long as the battery terminals 70 and 80 contact the pogo pins 90 by automatically detecting polarity and reversing the polarity if necessary. The disclosed features are merely a brief discussion of the preferred features. The housing 20 includes associated electronic circuitry as will be discussed in detail hereinbelow.

The typical battery 60 includes two contacts or terminals 70 and 80 which are aligned with any two pogo pins 90 for charging. The pogo pins 90 are spaced such that the battery 60 is simply put onto the platform anywhere between the end pogo pins 90, and two pogo pins 90 will mate with the terminals 70 and 80 of the battery 60. It is noted that the matrix of pogo pins 90 include multiple rows of to accommodate flexibility in mating to the height of the battery terminals 70 and 80 as it rest on the platform 30. The spacing of the pogo pins 90 horizontally across the end 50 accounts for the spacing between the terminals 70 and 80. The matrix of pins 90 includes a first set of end pogo pins 130 (only one visible form this perspective) at one end of the matrix 90 and a second set of end pogo pins 140 on the other end of the matrix 90. One boundary position of the range of plurality of positions of the battery 60 is when the first set of contacts 130 contact battery terminals 70 or 80, and other boundary position of the range at the other end is formed when the second set of contact 140 contacts the battery terminals 70 or 80.

Consequently, the battery charger 10 of the present invention requires minimum or no instructions at all since it is self-instructive as to the installation of the battery.

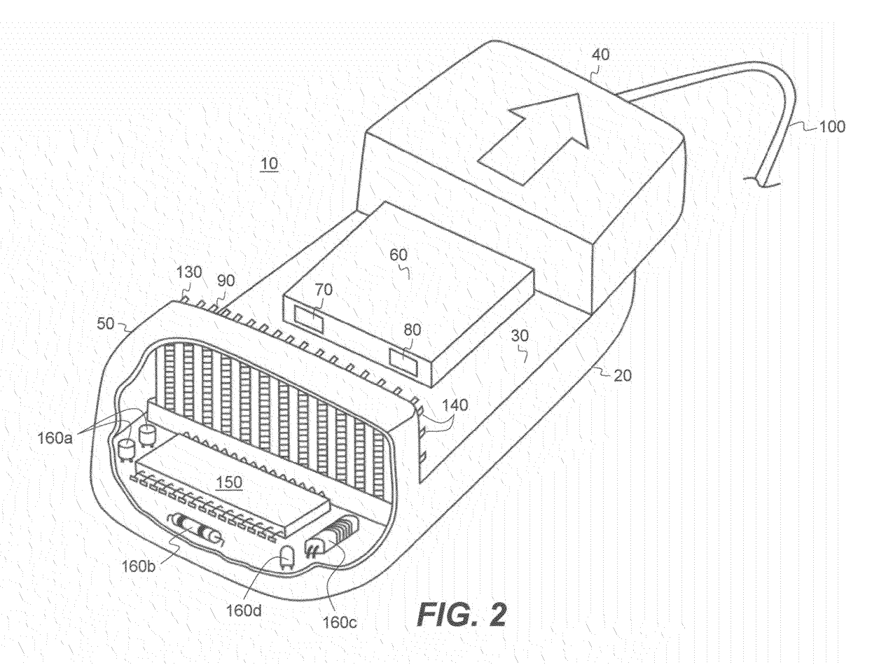

Referring to FIG. 2, there is shown a perspective view of the battery charger 10 with a portion of the housing 20 cut-away for illustrating some of the circuitry of the battery charger 10. In this regard, a microprocessor 150 is disposed in the housing 20 for directing operations of the battery charger 10. More specifically, the microprocessor 150 is electrically connected to the matrix of pogo pins 90 for testing and monitoring the polarity of the pogo pins 90 in contact with the battery terminals 70 and 80. Once the battery 60 is inserted onto the platform 30 with the battery terminals 70 and 80 mated to two pogo pins 90 and the microprocessor 150 knowing the polarity, the microprocessor 150 sends a signal to a charging circuit 160 for indicating which particular pogo pins 90, positive and negative, are to be used for charging. It is noted that the charging circuit 160 is composed of a number of components (160a, 160b, 160c and 160d) which is collectively referred to herein as the charging circuit 160. The charging circuit 160 then sends the correct voltage and/or current through the correct pogo pins 90 to the corresponding positive and negative terminals 70 and 80.

The advantage of the present invention is that it permits flexibility in its ability to charge batteries of different sizes. The matrix of pogo pins 90 permits flexibility in adjusting to the terminal positions of the battery 60 and the movable end 40 adjusts for the different lengths of the batteries 60. In combination with this flexibility, the consumer does not have to install the battery in a predetermined orientation because the microprocessor 150 will detect the battery terminal polarity and cause the charging circuit to charge accordingly. The battery detection can be implemented by using the apparatus or an apparatus substantially similar to the detection device of U.S. Pat. No. 7,449,875 which is incorporated herein by reference.

The microprocessor 150 also detects if two or more pogo pins 90 contact a same battery terminal 70 or 80 and applies a voltage to only one of the pogo pins 90 contacting the same terminal 70 or 80. This also increases flexibility since the user does not have to be concerned that there is pogo pin duplicity on a particular battery terminal.

The invention has been described in detail with particular reference to certain preferred embodiments thereof, but it will be understood that variations and modifications can be effected within the spirit and scope of the invention. For example, circuitry may be used in lieu of the microprocessor 150. Still further, the end 50 may also be movable if design preferences indicate.

### PARTS LIST

10 battery charger
20 housing
30 charging platform
40 movable closed end
50 closed end
55 arrows indicating bi-directional movement
60 battery
70 terminal
80 terminal
90 pogo pins
100 power cord
110 charging display
120 ready display
130 first closed end
140 second closed end
150 microprocessor
160 electronic components

1. A battery charger for charging batteries of different sizes in which the batteries have a first and second terminal on one side of the battery, the battery charger comprising:
(a) a charging platform for receiving a battery;
(b) first and second closed ends disposed on opposite ends of the charging platform; wherein one of the closed ends is movable in first and second directions that span across at least a portion of the platform for respectively increasing and decreasing an area of the platform in which the battery rests for receiving batteries of different sizes;
(c) a matrix of pins disposed on one of the closed ends of the platform, wherein the pins are configured to electrically contact the battery in a plurality of positions within a predetermined range; and
(d) one or more electronic components for detecting polarity of the battery; wherein charging of the battery is performed according to the detected polarity.

2. The battery charger as in claim 1, wherein the pins are pogo pins.

3. The battery charger as in claim 2, wherein the pogo pins are disposed on the closed end which is stationary.

4. The battery charger as in claim 3, wherein the one or more electronic components apply a voltage to the battery contacts according to the detected polarity.

5. The battery charger as in claim 3 further comprising an indicator light for indicating initiation of successful charging of the battery.

6. The battery charger as in claim 3, wherein the one or more electronic components detect if two or more pogo pin contacts a same terminal and applies voltage to only one of the pogo pins contacting the same terminal.

7. The battery charger as in claim 3, wherein the matrix of pins includes at least a first end pogo pin at one end of the matrix and at least a second end pogo pin on the other end of the matrix; wherein one boundary position of the range is when the first terminal contacts the first end pogo pin, and other boundary position of the range is formed when the second terminal contacts the second end pogo pin.

8. The battery charger as in claim 3, wherein the movable end moves in a first direction so that an area of the platform is decreased for decreasing a dimension of the platform and moves in a second direction, different from the first direction, so that the area of the platform is increased for increasing a dimension of the platform.

9. The battery charger as in claim 8, wherein the movable end has a sliding motion when moved.

10. The battery charger as in claim 3, wherein the platform is a single, undivided unit.

11. The battery charger as in claim 2, wherein the pogo pins are disposed on the closed end which is movable.

12. A battery charger for charging batteries of different sizes in which the batteries have a first and second terminal on one side of the battery, the battery charger comprising:
(a) a charging platform for receiving a battery;
(b) first and second closed ends disposed on opposite ends of the charging platform; wherein one of the closed ends is movable in first and second directions that span across at least a portion of the platform for respectively increasing and decreasing an area of the platform in which the battery rests for receiving batteries of different sizes;
(c) a matrix of contacts disposed on one of the closed ends of the platform, wherein the contacts are configured to electrically contact the battery in a plurality of positions within a predetermined range; and
(d) one or more electronic components for detecting polarity of the battery; wherein charging of the battery is performed according to the detected polarity.
